(19) United States
(12) Patent Application Publication
(10) Pub. No.: US 2009/0077156 A1
(43) Pub. Date: Mar. 19, 2009

(54) Efficient constraint monitoring using adaptive thresholds

(76) Inventors: Srinivas Raghav Kashyap, Bangalore (IN); Rajeev Rastogi, Bangalore (IN); S. R. Jeyashankher, Bangalore (IN); Pushpraj Shukla, Kirkland, WA (US)

Correspondence Address: HARNESS, DICKEY & PIERCE, P.L.C., P.O. BOX 8910, RESTON, VA, 20195, US

(21) Appl. No.: 12/010,942

(22) Filed: Jan. 31, 2008

Related U.S. Application Data
(60) Provisional application No. 60/993,790, filed on Sep. 14, 2007.

(51) Int. Cl. G06F 15/177; G06F 15/16

(52) U.S. Cl. 709/201; 709/220

(57) ABSTRACT

Methods for tracking anomalous behavior in a network referred to as non-zero slack schemes are provided. The non-zero slack schemes reduce the number of communication messages in the network necessary to monitor emerging large-scale, distributed systems using distributed computation algorithms by generating more optimal local constraints for each remote site in the system.

### PRIORITY STATEMENT

This non-provisional patent application claims priority under 35 U.S.C. §119(e) to provisional patent application Ser. No. 60/993,790, filed on Jun. 8, 2007, the entire contents of which are incorporated herein by reference.

### BACKGROUND OF THE INVENTION

When monitoring emerging large-scale, distributed systems (e.g., peer to peer systems, server clusters, Internet Protocol (IP) networks, sensor networks and the like), network monitoring systems must process large volumes of data in (or near) real-time from a widely distributed set of sources. For example, in a system that monitors a large network for distributed denial of service (DDoS) attacks, data from multiple routers must be processed at a rate of several gigabits per second. In addition, the system must detect attacks immediately after they happen (e.g., with minimal latency) to enable networks operators to take expedient countermeasures to mitigate effects of these attacks.

Conventionally, algorithms for tracking and computing wide ranges of aggregate statistics over distributed data streams are used to process these large volumes of data. These algorithms apply to a general class of continuous monitoring applications in which the goal is to optimize the operational resource usage, while still guaranteeing that the estimate of the aggregate function is within specified error bounds. In most cases, however, transmitting the required amount of data across the network to perform distributed computations is impractical. To reduce the amount of communication, distributed constraints monitoring or distributed trigger mechanisms are utilized. These mechanisms reduce the communication needed to perform the computations by filtering out “uninteresting” events such that they are not communicated across the network. An “uninteresting” event refers to a change in value at some remote site that does not cause a global function to exceed a threshold of interest. In many cases, however, such mechanisms do not sufficiently reduce the necessary communication volume so as to provide efficient network monitoring, while still providing sufficient communication efficiency.

FIG. 1 illustrates a conventional distributed monitoring method utilizing what is referred to as a zero-slack scheme. In a zero-slack scheme, a central coordinator such as a network operations center s₀ assigns local constraint threshold values Tᵢ to each remote site s₁, . . . , sₙ according to Equation (1) shown below.

Tᵢ=T/n, ∀i ∈ [1, n] Equation (1)

In Equation (1), T is a global constraint threshold value for the system and n is the number of nodes or remote sites in the system. In one example, the global constraint threshold corresponds to the total number of bytes that passed the service provider network in the past second. FIG. 1 illustrates a conventional distributed monitoring method. The method shown in FIG. 1 will be discussed with regard to the conventional system architecture shown in FIG. 2.

Referring to FIG. 1, at step S502 if remote site sⱼ (where j=1, 2, 3, . . . ) observes a value of the variable xⱼ that is greater than its assigned local constraint threshold value Tⱼ, the site sⱼ determines that its local constraint threshold value Tⱼ has been violated. In response, the remote site sⱼ generates a local alarm transmission to notify the coordinator s₀ of the local constraint threshold violation at remote site sⱼ at step S504. The local alarm transmission also informs the coordinator s₀ of the observed value xⱼ causing the local alarm transmission. As discussed herein, variable xⱼ may be the total amount of traffic (e.g., in bytes) entering into a network through an ingress point. The variable xⱼ may also be an observed number of cars on the highway, an amount of traffic from a monitored network in a day, the volume of remote login (e.g., TELNET, FTP, etc.) requests received by hosts within the organization that originate from the external hosts, packet loss at a given remote site or network node, etc.

At step S506, when the coordinator s₀ receives the local alarm transmission from site sⱼ, the coordinator s₀ calculates an estimate of the global aggregate value according to Equation (2) shown below.

xⱼ+Σ_{i≠j}Tᵢ Equation (2)

In Equation (2), each local constraint Tᵢ represents an estimate of the current value of variable xᵢ at each node other than xⱼ, which are known at the central coordinator s₀. At step S508, the central coordinator s₀ then determines whether Equation (3) is satisfied.

xⱼ+Σ_{i≠j}Tᵢ≦T Equation (3)

If Equation (3) is not satisfied, the central coordinator s₀ sends a message requesting current values of the variable xᵢ to each remote site s₁, . . . , sₙ at step S510. This transmission of messages is referred to as a “global poll.” In response, each remote site sends an update message including the current value of the variable xᵢ. Using these obtained values for variables x₁, x₂, . . . xₙ, the central coordinator s₀ determines if the global network constraint threshold T has been violated at step S512.

That is, for example, the central coordinator s₀ aggregates the values for variables x₁, x₂, . . . xₙ and compares the aggregate value with the global constraint threshold. If the aggregate value is greater than the global constraint threshold, then the central coordinator s₀ determines that the global constraint threshold T is violated. If the central coordinator s₀ determines that the global constraint threshold T is violated, the central controller s₀ records violation of the global constraint threshold in a memory at step S514. In one example, the central controller s₀ may generate a log, which includes time, date, and particular values associated with the constraint threshold violation.

Returning to step S512, if the central coordinator s₀ determines that the global constraint threshold Tis not violated, the process terminates and no action is taken. Returning to step S508, if the central coordinator s₀ determines that Equation (3) is satisfied, the central coordinator s₀ determines that a global poll is not necessary, the process terminates and no action is taken.

This method is an example of a zero slack scheme in which the sum of the local thresholds Tᵢ for all remote sites in the network is equal to the global constraint threshold T, or in other words,

$${\sum }_{i = 1}^{n} {T}_{i} = T .$$

In this case, a local alarm transmission results in a global poll by the central coordinator s₀ because any violation of a local constraint threshold for any node causes the central coordinator s₀ to estimate that the global constraint threshold T is violated. Using a zero-slack scheme, however, results in relatively high communication costs due to the frequency of local alarms and global polls.

### SUMMARY

Example embodiments provide methods for tracking anomalous behavior in a network referred to as non-zero slack schemes, which may reduce the number of communication messages in the network (e.g., by about 60%) necessary to monitor emerging large-scale, distributed systems using distributed computation algorithms.

In illustrative embodiments, system behavior (e.g., global polls) is determined by multiple values at the various sites, and not a single value as in the conventional art. At least one illustrative embodiment uses Markov's Inequality to obtain a simple upper bound that expresses the global poll probability as the sum of independent components, one per remote site involving the local variable plus constraint at the remote site. Thus, optimal local constraints (e.g., the local constraints that minimize communication costs) may be computed locally and independently by each remote site without assistance from a central coordinator.

Non-zero slack schemes according to illustrative embodiments discussed herein may result in lower communication costs.

### BRIEF DESCRIPTION OF THE DRAWINGS

FIG. 1 illustrates a conventional method for distributed monitoring;

FIG. 2 is a conventional system architecture;

FIG. 3 is a flow chart illustrating a method for generating and assigning local constraints to remote sites in a system according to an illustrative embodiment;

FIG. 4 is a flow chart illustrating a method for generating a local constraint using the Markov-based algorithm according to an illustrative embodiment; and

FIG. 5 is a flow chart illustrating a method for generating a local constraint for a remote site using a reactive algorithm according to an illustrative embodiment.

### DETAILED DESCRIPTION OF THE INVENTION

Illustrative embodiments are directed to methods for generating and/or assigning local constraints to nodes or remote sites within a network and methods for tracking anomalous behavior using the assigned local constraint thresholds. Anomalous behavior may be used to indicate that action is required by a network operator and/or system operations center. The methods described herein utilize non-zero slack scheme algorithms for determining local constraints that retain some slack in the system.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing central coordinators or nodes/remote sites. Such existing hardware may include one or more digital signal processors (DSPs), application-specific-integrated-circuits (ASICs), field programmable gate arrays (FPGAs) computers or the like.

Where applicable, variables or terms used in the following description refer to and are representative of the same values described above. In addition, the terms threshold and constraint may be considered synonymous and may be used interchangeably.

Unlike zero-slack schemes, in the disclosed non-zero slack schemes, each remote site is assigned a local constraint (or threshold) Tᵢ such that

$${\sum }_{i = 1}^{n} {T}_{i} \leq T ,$$

where T is again the global constraint threshold for the system and n is the number of nodes in the system. In such a non-zero slack scheme, the slack SL refers to the difference between the global threshold value and the sum of the remote site threshold values in the system. More particularly, the slack is given by

$$SL = T - {\sum }_{i = 1}^{n} {T}_{i} .$$

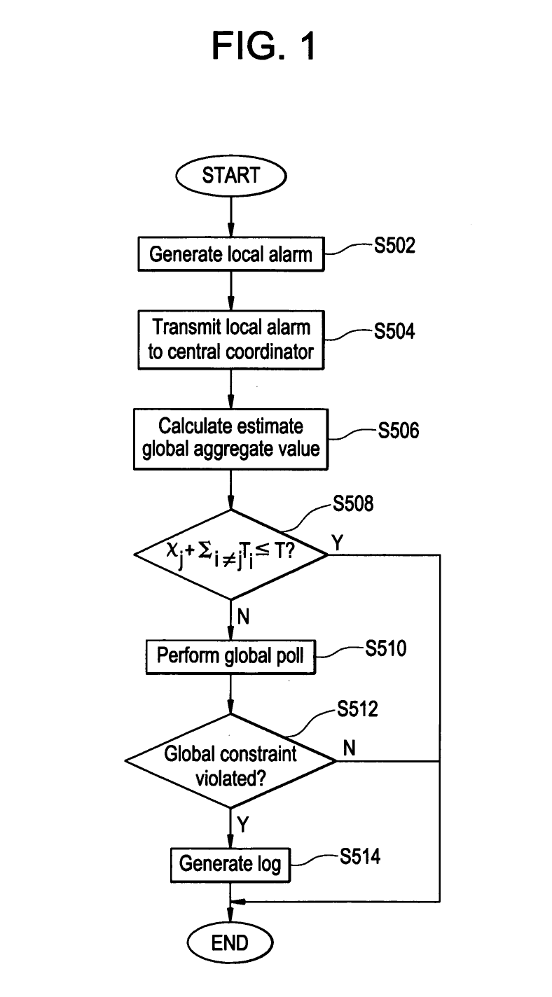

Illustrative embodiments will be described herein as being implemented in the conventional system architecture of FIG. 1 discussed above. However, it will be understood that illustrative embodiments may be implemented in connection with any other network or system.

As is the case in the conventional zero-slack schemes, the global constraint may be decomposed into a set of local thresholds, Tᵢ at each remote site sᵢ. Unlike the zero-slack schemes, however, in illustrative embodiments local constraint values (hereinafter local constraints) Tᵢ may be generated and/or assigned such that

$${\sum }_{i = 1}^{n} {T}_{i} \leq T .$$

In effect, generating and/or assigning local constraints Tᵢ satisfying

$${\sum }_{i = 1}^{n} {T}_{i} \leq T$$

filters out “uninteresting” events in the system to reduce the amount of communication overhead. As noted above, an “uninteresting” event is a change in value at some remote site that does not cause a global function to exceed a threshold of interest.

### Brute-Force Algorithm

One embodiment provides a method for assigning local constraints to nodes in a system using a “brute force” algorithm. The method may be performed at the central coordinator s₀ in FIG. 1.

FIG. 3 is a flow chart illustrating a method for generating and assigning local constraints to remote sites in a system according to an illustrative embodiment. The communication between the central coordinator s₀ and each remote site sᵢ may be performed concurrently.

Referring to FIG. 3, at step S202 the central coordinator s₀ receives histogram updates in an update message. As discussed above, each site sᵢ (wherein i=1, . . . , n) observes a continuous stream of updates, which it records as a constantly changing value of its local variable xᵢ. As was the case with xⱼ, variable xᵢ may be the total amount of traffic (e.g., in bytes) entering into a network through an ingress point. The variable xᵢ may also be an observed number of cars on the highway, an amount of traffic from a monitored network in a day, the volume of remote login (e.g., TELNET, FTP, etc.) requests received by hosts within the organization that originate from the external hosts, packet loss at a given remote site or network node, etc.

In one example, each remote site si maintains a histogram of the constantly changing value of its local variable xᵢ observed over time as Hᵢ(v), ∀v ∈ [0, T], where Hᵢ(v) is the probability of variable xᵢ having a value v). The update messages may be sent and received periodically, wherein the period is referred to as the recompute interval.

At step S204, in response to receiving the update messages from the remote sites, the central coordinator s₀ generates (calculates) local constraints Tᵢ for each remote site sᵢ. The central coordinator s₀ may generate local constraints Tᵢ based on a total system cost C as will be described in more detail below.

In one example, the coordinator s₀ first calculates a probability Pₗ(i) of a local alarm for each individual remote site (hereinafter local alarm probability) according to Equation (4) shown below.

$${P}_{l} ( i ) = Pr ( {x}_{i} > {T}_{i} ) = 1 - {\sum }_{j = 0}^{{T}_{i}} {H}_{i} ( j ) \qquad Equation ( 4 )$$

In Equation (4), Pr(xᵢ>Tᵢ) is the probability that the observed value at remote site sᵢ is greater than its threshold Tᵢ and is independently calculated for a given local constraint Tᵢ. Thus, the local alarm probability Pₗ(i) is entirely independent of the state of the other remote sites. In other words, the local alarm probability Pₗ(i) for each remote site sᵢ is independent of values of variable xᵢ at other remote sites in the system.

In addition to determining a local alarm probability for each remote site, the central coordinator s₀ determines a probability P_{g} of a global poll (hereinafter referred to as a global poll probability) in the system according to Equation (5) shown below:

$${P}_{g} = Pr ( Y > T ) = 1 - {\sum }_{v = 0}^{T} Pr ( Y = v ) \qquad Equation ( 5 )$$

In Equation (5), Y=ΣᵢYᵢ, and Yᵢ is an estimated value for xᵢ at each remote site sᵢ in the system. The estimated values Yᵢ are stored at the coordinator s₀ such that Yᵢ≧xᵢ at all times. The central coordinator s₀ updates the stored values Yᵢ based on values xᵢ reported in local alarms from each remote site. In a more specific example, the coordinator s₀ receives updates for values xᵢ at remote site sᵢ via a local alarm message generated by remote site sᵢ once the observed value xᵢ exceeds its local constraint Tᵢ. The stored values Yᵢ at the central coordinator s₀ for each remote site may be summarized as:

$${Y}_{i} = \{ \begin{matrix}{x}_{i} for each {s}_{i} that reports a local alarm ; and \\ {T}_{i} for each {s}_{i} that has not reported anything .\end{matrix}$$

Still referring to Equation (5), Pr(Y=v) is the probability that Y=ν, where ν is a constant, which may be chosen by a network operator. The central coordinator s₀ computes the probability Pr(Y=v) using a dynamic programming algorithm with pseudo-polynomial time complexity of O(nT²). As is well-known, O(nT²) is a standard notation indicating running time of an algorithm. Unlike the local alarm probability Pₗ, the global alarm probability P_{g} is dependent on the state of all remote sites in the system. In other words, the global alarm probability P_{g} is dependent on values of variable xᵢ at other remote sites in the system.

Still referring to step S204 of FIG. 3, the central coordinator s₀ generates the local threshold Tᵢ for remote site sᵢ based on the total system cost C given by Equation (6) shown below.

$$C = {P}_{g} {C}_{g} + {\sum }_{i = 1}^{n} {P}_{l} ( i ) {C}_{l} \qquad ( 6 )$$

In Equation (6), Pₗ(i) is the local alarm probability at site sᵢ, P_{g} is the global poll probability, Cₗ is the cost of a local alarm transmission message from remote site sᵢ to the coordinator s₀ and C_{g} is the cost of performing a global poll by the central coordinator s₀. Typically, Cₗ is O(l) and C_{g} is O(n), where O(l) and O(n) differ by orders of magnitude. In one example, O(l) is a constant independent of the size of system and O(n) is a quantity that grows linearly with the size of the system.

For instance, if there are 1000 remote sites in the system, then Cₗ may be a first value (e.g., 10) and C_{g} is another value (e.g., 100). As the network increases in size, (e.g., by adding another 9000 nodes), Cₗ remains close to 10, but C_{g} increases much larger than 100. As such, C_{g} grows much faster than Cₗ as network size increases.

More specifically, the central coordinator s₀ generates local constraints Tᵢ for each remote site sᵢ to minimize the total system cost C.

In one example, the central coordinator s₀ performs a naive exhaustive enumeration of all Tⁿ possible sets of local threshold values to generate the local constraints at each remote site that result in minimum total system cost C. For each combination of threshold values, the local alarm probability Pₗ(i) at each remote site sᵢ and the global poll probability P_{g} value are calculated to determine the total system cost C. In this case, this naive enumeration has a running time of O(nTⁿ⁺²).

To reduce the running time, only local threshold values in the range [Tᵢ−δ, Tᵢ+δ] for a small constant δ may be considered. The small constant δ may be determined experimentally and assigned, for example, by a network operator at a network operations center.

Returning to FIG. 3, at step S206, the central coordinator s₀ sends each generated local constraint Tᵢ to its corresponding remote site sᵢ.

### Markov-Based Algorithm

Another illustrative embodiment provides a method for generating local constraints using a Markov-based algorithm. This embodiment uses Markov's inequality to approximate the global poll probability P_{g} resulting in a decentralized algorithm, in which each site sᵢ may independently determine its own local constraint Tᵢ. As is well-known, in probability theory, Markov's inequality gives an upper bound for the probability that a non-negative function of a random variable is greater than or equal to some positive constant.

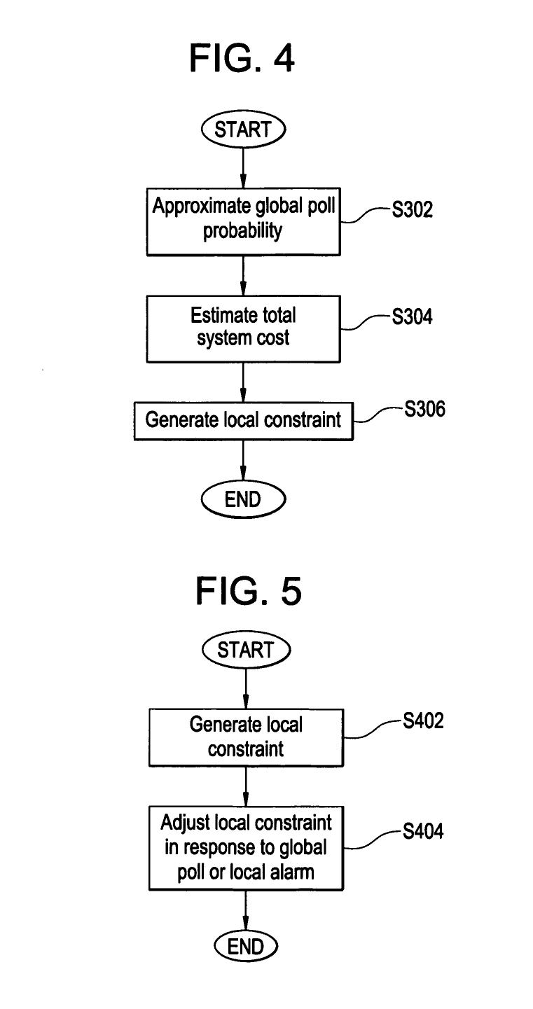

FIG. 4 is a flow chart illustrating a method for generating a local constraint using the Markov-based algorithm according to an illustrative embodiment. As noted above, the method shown in FIG. 4 may be performed at each individual remote site in the system.

Referring to FIG. 4, at step S302, using a Markov's inequality, remote site sᵢ approximates a global poll probability P_{g} according to Equation (7) shown below.

$${P}_{g} = Pr ( Y > T ) \leq \frac{E [ Y ]}{T} = \frac{E [ {\sum }_{i = 1}^{n} {Y}_{i} ]}{T} = \frac{{\sum }_{i = 1}^{n} E [ {Y}_{i} ]}{T} \qquad Equation ( 7 )$$

The approximation of the global poll probability P_{g} obtained by the remote site sᵢ represents the upper bound on the global poll probability P_{g}. Using this upper bound, at step S304, the remote site sᵢ estimates the total system cost C using Equation (8) shown below.

$$C = {\sum }_{i = 1}^{n} {C}_{l} {P}_{l} ( i ) + {C}_{g} {P}_{g} \leq {\sum }_{i = 1}^{n} {C}_{l} {P}_{l} ( i ) + \frac{{C}_{g}}{T} {\sum }_{i = 1}^{n} E [ {Y}_{i} ] \\ C \leq {\sum }_{i = 1}^{n} ( {C}_{l} {P}_{l} ( i ) + \frac{{C}_{g}}{T} E [ {Y}_{i} ] ) \qquad Equation ( 8 )$$

In Equations (7) and (8), the remote site's estimated individual contribution to the total system cost E[Yᵢ] is given by Equation (9) shown below.

$$E [ {Y}_{i} ] = {\sum }_{v = 0}^{T} {Y}_{i} Pr ( {Y}_{i} = v ) = {\sum }_{v = 0}^{{T}_{i}} {T}_{i} {H}_{i} ( v ) + {\sum }_{v = {T}_{i} + 1}^{T} {vH}_{i} ( v ) \qquad Equation ( 9 )$$

In Equation (9), Pr(Yᵢ=v) is the probability that the estimated value Yᵢ has the value v.

Referring back to FIG. 4, at step S306 the remote site sᵢ independently determines the local constraint Tᵢ based on its estimated individual contribution E[Yᵢ] to the estimated total system cost C given by Equation (8). More specifically, for example, the remote site sᵢ independently calculates the local constraint Tᵢ that minimizes its contribution to the estimated total system cost C, thus allowing the remote site sᵢ to calculate its local constraint Tᵢ independent of the coordinator s₀.

The remote site sᵢ may calculate its local constraint Tᵢ by performing a linear search in the range 0 to T. Because such a search requires O(T) running time, the running time may be reduced to O(δ) by searching for the optimal threshold value in a small range [Tᵢ−δ, Tᵢ+δ]. The linear search performed by the remote site sᵢ may be performed at least once during each round or recompute interval. Each time remote site sᵢ recalculates its local constraint Tᵢ, the remote site sᵢ reports the newly calculated local constraint to the central coordinator s₀ via an update message.

If each remote site in the system is allowed to independently determine their local threshold values, ensuring that

$${\sum }_{i = 1}^{n} {T}_{i} \leq T$$

is satisfied may not be guaranteed. To ensure that

$${\sum }_{i = 1}^{n} {T}_{i} \leq T$$

is satisfied, each remote site's local constraint may be restricted to a maximum of T/n by the central coordinator s₀. However, such a restriction may reduce performance in cases where one site's value is very high on average compared to other sites.

Alternatively, to ensure that the sum of the threshold values is bounded by T, the coordinator s₀ may determine if

$${\sum }_{i = 1}^{n} {T}_{i} \leq T$$

is satisfied each recompute interval after having received update messages from the remote sites. If the central coordinator s₀ determines that

$${\sum }_{i = 1}^{n} {T}_{i} \leq T$$

is not satisfied, the coordinator s₀ may reduce each threshold value Tⱼ by

$$\frac{{T}_{j}}{{\sum }_{i = 1}^{n} {T}_{i}} ( {\sum }_{i = 1}^{n} {T}_{i} - T ) such that {\sum }_{i = 1}^{n} {T}_{i} \leq T$$

is satisfied.

### Reactive Algorithm

Another illustrative embodiment provides a method for generating local constraints using what is referred to herein as a “reactive algorithm.” The method for generating local constraints using the reactive algorithm may be performed at each remote site individually or at a central location such as central coordinator s₀.

If the method according to this illustrative embodiment is performed at individual remote sites, then each remote site reports the newly calculated local constraint to the central coordinator in an update message during each recompute interval. If the method according to this illustrative embodiment is performed at the central coordinator s₀, then the central coordinator s₀ assigns and sends the newly calculated local constraint to each remote site during each recompute interval. As noted above, the central coordinator s₀ and the remote sites may communicate in any well-known manner.

As was the case with the above-discussed embodiments, this embodiment will be described with regard to FIG. 1, in particular, with the method being executed at remote site sᵢ.

In this embodiment, the remote site sᵢ determines its own local constraint Tᵢ based on actual local alarm and global poll events within the system.

FIG. 5 is a flow chart illustrating a method for generating a local constraint for a remote site using a reactive algorithm according to an illustrative embodiment.

Referring to FIG. 5, at step S402 the remote site sᵢ generates an initial local constraint Tᵢ, for example, using the above described Markov-based algorithm. At step S404, the remote site sᵢ then adjusts the local constraint Tᵢ based on actual global poll and local alarm events in the system.

For example, each time the remote site sᵢ transmits a local alarm, the remote site sᵢ determines that the local constraint Tᵢ may be lower than an optimal value. In this case, the remote site sᵢ may increase its local constraint Tᵢ value by a factor α with a probability 1/ρᵢ (or 1, if 1/ρᵢ is greater than 1), where α and ρᵢ are parameters of the system greater than 0. In other words, the local constraint at remote site sᵢ is not always increased in response to generating a local alarm, but rather is increased probabilistically. In one example, system parameter α is a constant selected by a network operator at the network operations center and is indicative of the rate of convergence. In one example, α may take values between about 1 and about 1.2, inclusive (e.g., α=1.1). Parameter ρᵢ is computed according to Equation (10) discussed in more detail below.

Each time the remote site sᵢ receives a global poll, which is not generated in response to a self-generated local alarm, the remote site sᵢ determines that its local constraint Tᵢ may be higher than an optimal value. In this case, the remote site sᵢ may reduce the threshold value by a factor of α with a probability ρᵢ (or 1, if ρᵢ is greater than 1). In other words, the local constraint at remote site sᵢ is not always decreased in response to a global poll, but rather is decreased probabilistically.

As noted above, to obtain a more optimal local threshold Tᵢ^{opt}, parameter ρᵢ may be set according to Equation (10) shown below.

$${ρ}_{i} = \frac{{P}_{l} ( {T}_{i}^{opt} )}{{P}_{g}^{opt}} \qquad Equation ( 10 )$$

In Equation (10), probability Pₗ(Tᵢ^{opt}) is the local alarm probability when the local threshold is set to Tᵢ^{opt} and the probability P_{g}^{opt} is the global probability when all remote sites take the optimal local constraint values.

Equation (10) can be shown to be a valid value for ρᵢ because if each remote site sᵢ does not have an optimal local constraint Tᵢ^{opt}, then either (A) the current local constraint Tᵢ′>Tᵢ^{opt}, Pₗ(Tᵢ′)<Pₗ(Tᵢ^{opt}) and P_{g}(Tᵢ′)>P_{g}(Tᵢ^{opt}), or (B) current local constraint Tᵢ′<Tᵢ^{opt}, Pₗ(Tᵢ′)>Pₗ(Tᵢ^{opt}) and P_{g}(Tᵢ′)<P_{g}(Tᵢ^{opt}).

In case (A), if Tᵢ′>Tᵢ^{opt}, Pₗ(Tᵢ′)<Pₗ(Tᵢ^{opt}) and P_{g}(Tᵢ^{opt})>P_{g}(Tᵢ^{opt}) at site sᵢ, then

$$\frac{{P}_{l} ( {T}_{i}^{′} )}{{P}_{g} ( {T}_{i}^{′} )} < \frac{{P}_{l} ( {T}_{i}^{opt} )}{{P}_{g} ( {T}_{i}^{opt} )}$$

and Pₗ(Tᵢ′)<ρᵢP_{g}(Tᵢ′). In this case, the average number of observed local alarms is less than ρᵢ times the average number of observed global polls. Thus, the local constraint value decreases over time from Tᵢ^{l}.

In case (B), if Pₗ(Tₗ′)>Pₗ(Tᵢ^{opt}), and P_{g}(Tᵢ′)<P_{g}(Tᵢ^{opt}) at site sᵢ, then

$$\frac{{P}_{l} ( {T}_{i}^{′} )}{{P}_{g} ( {T}_{i}^{′} )} > \frac{{P}_{l} ( {T}_{i}^{opt} )}{{P}_{g} ( {T}_{i}^{opt} )}$$

and Pₗ(Tᵢ′)<ρᵢP_{g}(Tᵢ′). Similarly, the threshold value will increase if the threshold is less than Tᵢ^{opt}.

Given the above discussion, one will appreciate that the stable state of the system is reached when local constraints are optimized (e.g., Tᵢ^{opt}) using the reactive algorithm. Once the system reaches a stable state (at the optimal setting of local constraints), the communication overhead is minimized compared to all other states.

In an alternative embodiment, the remote site sᵢ may utilize the Markov-based method to determine the local constraint Tᵢ that minimizes the total system cost C and use this value to compute the contribution of the remote site to P_{g}.

In this embodiment, the remote site sᵢ sends its individual estimated contribution E[Yᵢ] of P_{g} to the central coordinator s₀ at least once during or at the end of each recompute interval. The central coordinator s₀ sums (or aggregates) the components of P_{g} received from the remote sites and computes the P_{g} value. The coordinator s₀ sends this value of P_{g} to each remote site, and each remote site uses this received value of P_{g} to compute parameter ρᵢ. Illustrative embodiments use an estimate of P_{g} provided by the central coordinator s₀ to compute ρᵢ at each remote site. The remaining portions of information necessary are available locally at each remote site.

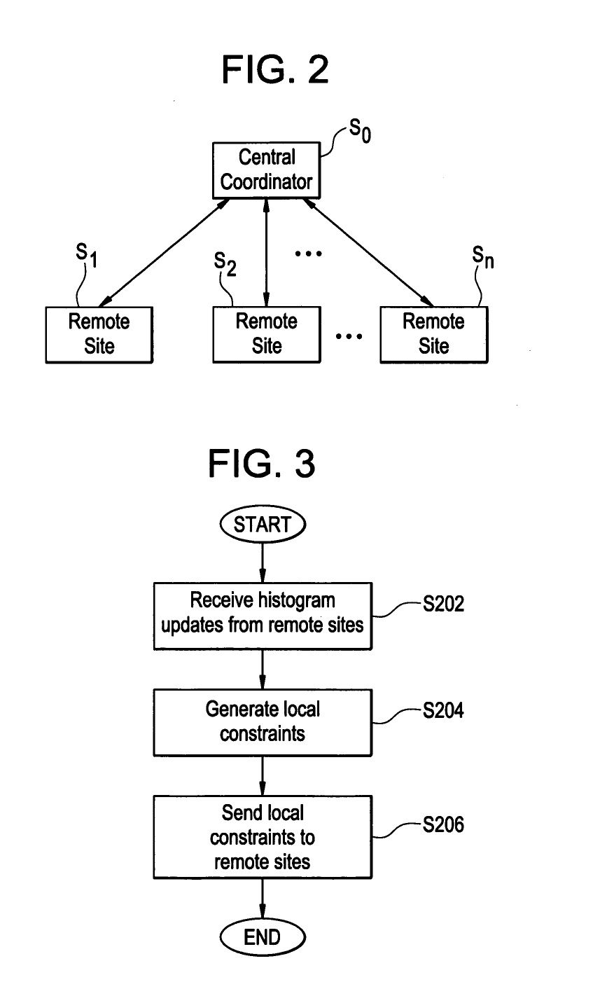

The above discussed embodiments may be used to generate and/or assign local thresholds to remote sites in the system of FIG. 2, for example. Using these assigned local thresholds, methods for distributed monitoring may be performed more efficiently and system costs may be reduced. In one example, the local thresholds determined according to illustrative embodiments may be utilized in the distributed monitoring method discussed above with regard to FIG. 1.

In a more specific example, illustrative embodiments may be used to monitor the total amount of traffic flowing into a service provider network. In this example, the monitoring setup includes acquiring information about ingress traffic of the network. This information may be derived by deploying passive monitors at each link or by collecting flow information (e.g., Netflow records) from the ingress routers (remote sites). Each monitor determines the total amount of traffic (e.g., in bytes) coming into the network through that ingress point. If the total amount of traffic exceeds a local constraint assigned to that ingress point, the monitor generates a local alarm. A network operations center may then perform a global poll of the system, and determine whether the total traffic across the system violates a global threshold, that is, a maximum total traffic through the network.

In a more specific example, illustrative embodiments discussed herein may be used to detect service quality degradations of VoIP sessions in a network. For example, assume that VoIP requires the end-to-end delay to be within 200 milliseconds and the loss probability to be within 1%. Also, assume a path through the network with n network elements (e.g., routers, switches). To monitor loss probabilities through the network, each network element uses an estimate of its local loss probability, for example, lᵢ, i ∈ [1, n] and an estimate of the loss probability L of the path through these network elements given by L=1−(1−l₁)(1−l₂) . . . (1−lₙ), which re-arranges into log(1−L)=log(1−l₁)+log(1−l₂)+ . . . +log(1−lₙ). If a loss probability less than 0.01 is desired (e.g., L≦0.01), then log(1−L)≧log(0.99). Inverting the sign on both sides, this transforms into the constraint

$${\sum }_{i = 1}^{n} ( - log ( 1 - {l}_{i} ) ) \leq - log ( 0.99 ) .$$

In terms of the above-described illustrative embodiments, −log(1−lᵢ) is local constraint Tᵢ and −log(0.99) is global constraint T. Thus, the losses may be monitored in a network using distributed constraints monitoring. Delays can be monitored similarly using distributed SUM constraints.

In a similar manner, illustrative embodiments may be used to raise an alert when the total number of cars on the highway exceeds a given number and report the number of vehicles detected, identify all destinations that receive more than a given amount of traffic from a monitored network in a day, and report their transfer totals, monitor the volume of remote login (e.g., TELNET, FTP, etc.) request received by hosts thin the organization that originate from the external hosts, etc.

The invention being thus described, it will be obvious that the same may be varied in many ways. Such variations are not to be regarded as a departure from the invention, and all such modifications are intended to be included within the scope of the invention.

1. A method for assigning a local constraint to a remote site in a network, the method comprising:
generating, by a central controller, the local constraint for the remote site based on probabilities and system costs associated with a local alarm transmission by the remote site and a global poll in the network, the local constraint being generated in response to an update message received from at least one remote site in the network;
assigning the local constraint to the remote site.

2. The method of claim 1, further comprising:
calculating the probability of a local alarm transmission by the remote site based on a histogram update received from the remote site, the histogram update being indicative of current observation values at the remote site.

3. The method of claim 1, further comprising:
calculating the probability of a global poll based on an aggregate of estimated observation values for a plurality of remote sites in the network.

4. The method of claim 1, wherein the generating step further comprises:
estimating a total system cost associated with local alarm transmissions and global probabilities in the network based the probabilities and system costs associated with the local alarm transmission by the remote site and probabilities and system costs associated with a global poll in the network; and wherein
the generating step generates the local constraint based on the estimated total system cost.

5. The method of claim 1, further comprising:
transmitting the assigned local constraint to the remote site.

6. The method of claim 5, further comprising:
detecting, by the remote site, violation of the local constraint based on a current instantaneous observation value; and
generating a local alarm in response to the detected violation.

7. The method of claim 6, wherein the detecting step comprises:
comparing a current observation value with the local constraint; and
detecting violation of the local constraint if the current observation value is greater than the local constraint.

8. The method of claim 6, further comprising:
detecting, by the central controller, violation of a global constraint in response to the generated local alarm.

9. A method for generating a local network constraint value for a remote site in the network, the method comprising:
estimating, locally at the remote site, a total system cost based on probabilities and system costs associated with a local alarm and global polling of remote sites in the network; and
generating a local constraint based on the estimated total system cost such that the local constraint value is less than a maximum local constraint value, the maximum local constraint value being determined based on a number of nodes in the network and a global constraint for the network.

10. The method of claim 9, further comprising:
approximating, at the remote site, a probability of a global poll in the network based on a sum of expected system cost contributions of remote sites in the network and the global constraint; and wherein
the estimating step estimates the total system cost based on the probability of the global poll in the network.

11. The method of claim 9, further comprising:
detecting, by the remote site, violation of the local constraint based on a current observation value; and
generating a local alarm in response to the detected violation.

12. The method of claim 11, wherein the detecting step comprises:
comparing the current observation value with the local constraint; and
detecting violation of the local constraint if the current observation value is greater than the local constraint.

13. The method of claim 11, further comprising:
detecting, by the central controller, violation of a global constraint in response to the generated local alarm.

14. A method for adaptively assigning a local constraint to a remote site in a network, the method comprising:
generating a local constraint based on an estimated total system cost, the estimated total system cost being indicative of costs associated with local alarm transmissions and global polling of the network;
approximating a probability of a global poll in the network based on a sum of expected system cost contributions of the remote site and the generated global constraint; and
probabilistically adjusting a local constraint value at the remote site in the network by a first factor in response to a local alarm or global poll event in the system.

15. The method of claim 14, wherein the adjusting step further comprises:
probabilistically increasing a local network constraint for a first node in response to a local alarm generated by the remote site; or probabilistically decreasing local network constraint values for at least a portion of the nodes in the network in response to a global poll event.

16. The method of claim 14, further comprising:
detecting, by the remote site, violation of the local constraint based on a current observation value; and
generating a local alarm in response to the detected violation.

17. The method of claim 16, wherein the detecting step comprises:
comparing the current observation value with the local constraint; and
detecting violation of the local constraint if the current observation value is greater than the local constraint.

18. The method of claim 16, further comprising:
detecting, by the central controller, violation of a global constraint in response to the generated local alarm.
